(19) United States
(12) Patent Application Publication
(10) Pub. No.: US 2009/0261498 A1
(43) Pub. Date: Oct. 22, 2009

(54) METHOD AND APPARATUS FOR THE MANUFACTURE OF A FIBER

(75) Inventors: Michael RHEINNECKER, Aachen (DE); Stefan KOHLHAAS, Voerde (Niederrhein) (DE); Rolf ZIMMAT, Dusseldorf (DE)

Correspondence Address: INTELLECTUAL PROPERTY / TECHNOLOGY LAW, PO BOX 14329, RESEARCH TRIANGLE PARK, NC, 27709, US

(73) Assignee: Spin'tec Engineering GmbH, Aachen (DE)

(21) Appl. No.: 12/433,198

(22) Filed: Apr. 30, 2009

Related U.S. Application Data
(63) Continuation-in-part of application No. PCT/EP2007/009430, filed on Oct. 30, 2007.
(60) Provisional application No. 60/863,573, filed on Oct. 30, 2006.

(30) Foreign Application Priority Data
Oct. 30, 2006 (GB) GB 0 621 496.9

(51) Int. Cl. B29C 47/34; B28B 5/02

(52) U.S. Cl. 264/176.1; 425/71

(57) ABSTRACT

An apparatus for the manufacture of extruded material. The apparatus includes a material supplier which supplies a material and has an opening, through which the material is extruded to form extruded material. A moving surface is positioned adjacent to the opening to receive the extruded material from the opening. The method for the extrusion of the material which comprises providing the material in a liquid form, extruding the material through an opening to form extruded material and receiving the extruded material on the moving surface.

### CROSS-REFERENCE TO RELATED APPLICATIONS

The present invention is a continuation in part under 35 USC 120 of international patent application PCT/EP2007/009430 filed 30 Oct. 2007 and claims the priority of said international patent application, as well as the priority and benefit of U.S. provisional patent application 60/863,573 filed Oct. 6, 2006. The disclosures of said international patent application PCT/EP2007/009430 and U.S. provisional patent application 60/863,573 are hereby incorporated herein by reference, in their respective entireties.

### FIELD OF THE INVENTION

The application relates to an apparatus and method for the extrusion of materials.

### PRIOR ART

Industrial production of man-made fibers, described for example in the Complete Textile Glossary of Hoechst Celanese (Customer Information 2001, Celanese Acetate LLC), uses spinning techniques by which polymer solutions or melts are extruded with high pressure through spinnerets as extruded material (also called an extrudate) to form fibers at a nozzle exit (fiber formation point) which are collected by take-up wheels at some distance from the nozzle exit.

Fiber formation occurs between the nozzle exit and the take-up wheel through polymer crystallization or solvent precipitation which can be induced and controlled by cooling, solvent evaporation or chemical treatment. Given those well established chemical and physical treatment steps, any additional mechanical support of the extrudate after exiting from the spinning nozzle for the purpose of controlling the fiber crystallisation process is not a preferred solution for industrial spinning processes.

Two types of spinning are generally known in the art (see Fundamentals of Fiber Formation, Andrzej Ziabicki, John Wiley & Sons). Melt-spinning is carried out using molten polymers and dry spinning or wet spinning is carried out from solution. A typical fiber spinning process is disclosed in European Patent EP 593967 and in the International Patent Application No WO 03/060207 (in the latter application a so-called dry-jet-wet spinning process is disclosed). In the two cited patent documents a spin solution based on a polypeptide is disclosed. Similar methods have been known for some time in connection with the spinning of cellulose fibers, as is described in U.S. Pat. No. 4,246,221.

The aforementioned conventional spin solutions can be extruded through a spinneret at a relatively high speed because of their rheological properties. The solution emerges from the spinneret as a liquid jet with a large amount of kinetic energy and enters a coagulation bath. The fiber is formed in an air gap or a non-precipitation medium between the spinneret and the coagulation bath and a pre-orientation of the polymers is carried out. Finally the fibers are precipitated in the coagulation bath (see U.S. Pat. No. 446,221).

A similar method is further described in U.S. Pat. No. 4,344,908. The U.S. Pat. No. '908 patent discloses a spinning solution which is extruded through an air gap or non-precipitation medium into a cooler device in order to create a precursor filament from a polymer gel. The precursor filament is then warmed in a classical dry spinning method and subsequently expanded.

In contrast to those established processes for man-made fiber production, according to a recent review by Scheibel in Current Opinion in Biotechnology 2005, 16, 427-433, all efforts have failed to apply conventional spinning techniques to spin feedstocks such as biological materials like spidroin proteins. Hence, despite the high level of technical development of established spinning techniques, it has thus far been impossible according to the Scheibel review paper to apply economically attractive and technically robust industrial spinning processes to certain feedstocks. Similarly it has thus far not been possible to use the benign process parameters used by nature (aqueous buffers, room temperature and normal pressure) to manufacture materials such as fibers, films or coatings on an industrial scale.

European Patent No EP 1 244 828 teaches an apparatus and method for the manufacture of fibers from protein feedstocks using a spinneret and a take-up drum. However, the take-up drum of this application is a passive item of the apparatus, situated at a substantial distance from the spigot or exit of the spinneret. The formation of the fibers in the '828 patent Application takes place within the body of the spinneret and not on the take-up drum of this application. However, the fiber formation inside the spinneret may not be ideal for those natural feedstocks which exhibit large variations in feedstock parameters, such as homogeneity and concentration. Those variations in feedstock parameters may result in fluctuations of the fiber formation point during the spinning process and may increase the effort required for monitoring spinning of protein feedstocks using the method of the disclosure of EP 1 244 828.

UK Patent No. GB 385160 teaches an apparatus in which freshly spun artificial silk fibers are washed, desulphurised, bleached, oiled or dried. This patent teaches a post processing of fibers which have already been spun. This patent does not teach the spinning of the artificial silk fibers.

U.S. Pat. No. 5,252,277 is titled “Process for spinning polypeptide fibers from solutions of lithium thiocyanate band liquefied phenol” and is owned by E I Du Pont de Nemours and Company. The Du Pont patent discloses a process for manufacturing polypeptide solutions and spinning them into fibers. The process involves dissolving a polypeptide in a solvent system that comprises lithium thiocyanate (LiSCN) and a liquefied phenol. The process describes a web spinning process whereby the spinning solution is extruded directly into a coagulating bath. The coagulating bath comprises the lithium thiocyanate and liquefied phenol. The process described by Du Pont patent uses harsh chemicals to extrude the polypeptide fibers. The harsh chemicals used in the process described by the Du patent are polypeptide denaturing chemicals.

An article in Biomacromolecules 2002, 3, 232-238 by Matthews et al. is titled “Electrospinning of collagen nanofibers”. Matthews et al discloses fabrication process that uses an electric field to control the deposition of polymer fibers onto a target substrate. The biomacromolecules article discloses an electrospinning system comprising a grounded target, a high voltage source, a collagen reservoir and a nozzle. The fiber deposition can be regulated by controlling the motion of the grounded target and a source solution of collagen with respect to one and other. The method disclosed in the biomacromolecules document discloses the dissolution of collagen into a solvent of 1,1,1,3,3,3 hexafluoro-2-propoanol (HFP). Matthews et al does not disclose the use of water soluble material.

US Patent Publication No. 2005/0110186 is titled “Solvent casting process, polarizing plate protective film, optically functional film and polarizing plate” and is owned by The Fuji Photo Film company. The Fuji patent discloses a process for solvent casting including casting a dope from a casting die onto a casting support. The Fuji photo film company document discloses the casting of cellulose acetate films by a solvent casting method and apparatus. The Fuji patent application does not disclose an apparatus or method for the manufacture of a silk fiber from a water soluble material.

UK Patent Application No. 1,107,066 is titled “Improved process and apparatus for production of membranes” and is owned by General Dynamics Corporation. The General Dynamics patent application discloses the preparation of a casting solution by dissolving a film forming cellulosic ester, such as cellulose acetate, plus an aqueous solution of a pore-producing salt in an organic solvent. The General Dynamics document does not disclose a method or an apparatus that uses a water soluble material to manufacture of a silk fiber.

An article in Applied Physics Letters Volume 84, No 7, pages 1222-1224 by Sundaray et al. is titled “Electrospinning of continuous aligned polymer fibers”. Sundaray et al. discloses electrospinning for preparing polymer fibers using a voltage of 4500V and a separation distance of about 1 to 3 cm between electrodes to manufacture fibers with a separation between the fibers in the range of 5 to 100 μm. Sundaray et al. paper discloses that a smaller distance between the electrodes provides a better control on the formation of the polymer fibers. The fibers are manufactured from polystyrene and polymethylmethacrylate. Sundaray et al. does not disclose the manufacture of silk fibers from a water soluble material.

In the case of a spin solution which is sensitive to shear stresses, such as a protein solution, it is not possible to use the spin solution as the feedstock in a conventional spinning method as discussed above. The spin solution cannot be converted into the liquid jet as the solution would solidify due to the stress placed on the proteins in the spin solution and the rheological properties of the spin solution. Such spin solutions must be extruded extremely slowly and with great care. One known issue with such slow extrusion is the risk of formation of drops of the extruded material at the nozzle exit due to the surface energy of the material. As a result there is a need to first produce a precursor material with a particular shape and then, if necessary, chemically or physically treat the precursor material in a treatment zone. Finally, the fiber is pulled in order to allow self-assembly of the molecules within the fiber. The prior art discloses no method of producing such fibers.

### SUMMARY OF THE INVENTION

The term “material” in this application means any article and is intended to include fibers, films, coatings, filaments, threads and the like.

The invention comprises an apparatus with a material supplier which supplies the material and has an opening though which the material is extruded to form extruded material. A moving surface is positioned adjacent to the opening and receives the extruded material from the opening. In this invention, the extruded material does not pass through a large air gap but is extruded substantially directly onto the surface of the moving surface. The moving surface allows the extruded material to be transported into a treatment zone in which the chemical properties and physical properties of the extruded material are changed. The direct physical contact between the surface of the moving surface and the extruded material enables change of chemical and physical properties of the extruded material, thereby allowing precise control of conversion processes of the extruded material to form a finished product, such as the fiber, the film, the coating, etc.

The invention also comprises a method for the extrusion of materials which are mechanically strong and are made out of natural and man-made feedstocks.

The method and apparatus can also comprise a wet-spinning step. This can be done, for example, by using a solvent bath and passing the fiber through the solvent bath after the fiber has left the moving surface. Alternatively, the extruded material on the moving surface can be passed through the solvent bath before formation of the finished product.

The material can be treated in the material supplier prior to the exit of the extruded material from the opening and physical contact with the moving surface. A spinneret to allow the treatment of the material in the material supplier is described in U.S. Pat. No. 6,858,168 B1, owned by the applicant, and can be used to enable this treatment of the material within the spinneret.

The method and apparatus of the present invention allow the production of the finished products either as a batch process or a continuous process.

The apparatus and method of the present invention enables the use as materials not only of chemically synthesized polymers but also of macromolecules such as, for instance, biological materials which can be, but are not limited to, proteins, peptides, carbohydrates, lipids, nucleic acids or any combination or derivative thereof. The biological macromolecules include spidroin, fibroin, collagen, actin, elastin or other proteins conferring structural or functional properties to the end product of the invented manufacturing process.

The properties of the materials can be changed during formation of the material on the moving surface by transferring additives to the extruded material. The transfer of the additives can be either made through the moving surface or from the outside of the moving surface. The selection of the additives is extensive and only limited by the intended use of an end product from which the material is made. Examples of those additives include but are not limited to organic or inorganic chemicals changing the tensile strength or chemical properties of the finished product or conferring industrially useful properties to the finished products, such e.g. electrostatic, electric charge carrier or magnetic properties. Other additives may include therapeutically active substances, such as small molecular drug entities or proteins or metals such as silver.

The finished products of the invention can be used for a number of purposes including, but not limited to, the manufacture of two dimensional objects including, but not limited to, films, thin sheets and coatings or any two dimensional shape required by the intended use of the end products. The end products can also be used for the manufacture of three dimensional objects including, but not limited to, tubes, containers, fibers, massive objects, thick sheets and coatings or any three dimensional shape required by the intended use of the end product.

### DESCRIPTION OF THE DRAWINGS

FIG. 1 shows a first aspect of the extrusion apparatus.

FIG. 2 shows the method of use of the extrusion apparatus.

FIG. 3 shows stress strain curves of fibers produced using the extrusion apparatus.

FIG. 4 shows stress strain curves of fibers produced using the extrusion apparatus in wet mode.

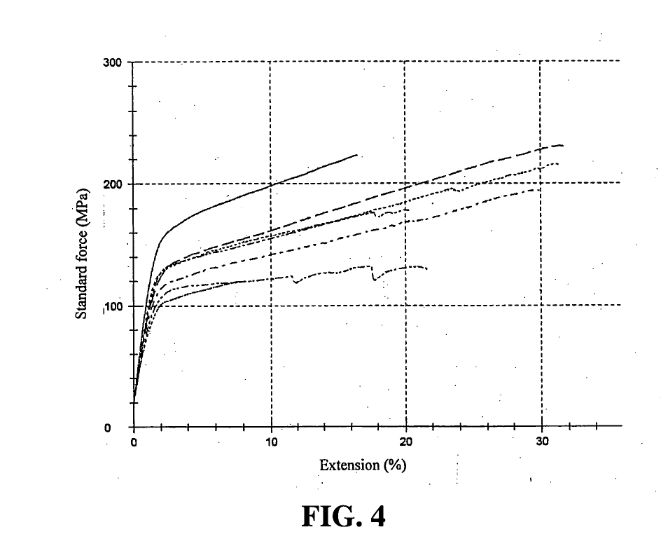

FIG. 5 shows another aspect of the extrusion apparatus.

### DETAILED DESCRIPTION OF THE INVENTION

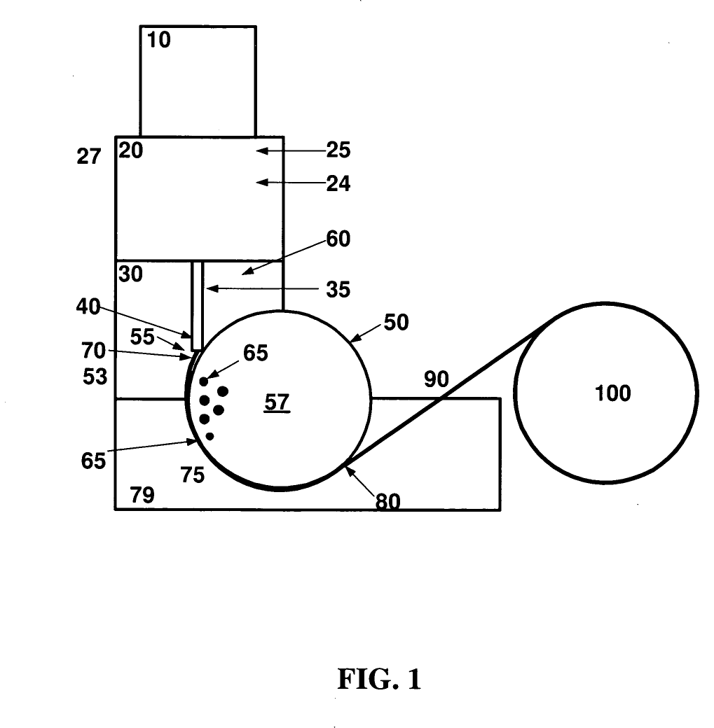

FIG. 1 shows an extrusion apparatus in accordance with one aspect of the invention. The extrusion apparatus comprises a feedstock pump 10, a feedstock reservoir 20 for storing material 25 to be extruded (called “feedstock”), a feedstock loading device 30 with a channel 35 and an opening 40 through which the feedstock 25 is passed and a moving surface 50. Optionally, the reservoir 20 may have permeable or semi-permeable walls. The feedstock 25 stored in the feedstock reservoir 20 includes chemically synthesized polymers and also macromolecules such as, for instance, biological materials which can be, but are not limited to, proteins, peptides, carbohydrates, lipids, nucleic acids or any combination or derivative thereof. The biological macromolecules may include spidroin, fibroin, collagen, actin, elastin or other proteins conferring structural or functional properties to a finished product of the manufacturing process.

The polymers used in the feedstock 25 are soluble in water, organic or inorganic solvents.

Optionally, the feedstock loading device 30 is filled with a reactive medium 60 which surrounds the channel 35. The channel 35 may have porous walls to allow at least some components from the reactive medium 60 to pass through the porous walls of the channel 35 and chemically or physically react with the feedstock 25. The components in the reactive medium 60 passing through the porous walls may be used at any stage of the process to support formation and crystallization of materials such as fibers as is explained in detail in U.S. Pat. No. 6,858,168, the disclosure of which is incorporated by reference.

The moving surface 50 comprises a take-up point 70, a treatment zone 75 and a material formation point 80. The feedstock 25 emerges from the opening 40 of the channel 35 in the feedstock loading device 30 and is accepted by a surface of the treatment device 50. The distance 55 between the opening 40 and the moving surface 50 is short. The distance 55 chosen is such that the feedstock 25 does not substantially solidify during the period of its exit from the opening 40 to the take up by the surface 50. In other words, the extruded material on the moving surface 50 is substantially fluid when the extruded material arrives on the surface of the moving surface 50. Typical distances would be between 0.1 mm and 50 mm.

The moving surface 50 is rotating and accepts the feedstock 25 at the take-up point 70. The moving surface 50 rotates the feedstock 25 as an extrudate into and through the treatment-zone 75 to the material formation point 80 at which point the extrudate—now converted into a fiber or film forming material—leaves the moving surface 50. Optionally, the treatment zone 75 may be realised as a treatment bath 79. The feedstock 25 changes its physical form on the moving surface 50 and in the treatment zone 75 from a substantially fluid form at the take-up point 70 on exit from the opening 40 of the feedstock loading device 30 to a substantially solid or gel form at the material formation point 80. The moving surface 50 is made, for example, from acryl, aluminium, steel or PTFE.

Optionally, the properties of the fiber or film forming material forming on the moving surface 50 can be further changed in the treatment zone 75 by conferring additives or functional elements 65 either through or from the outside of the moving surface 50 into the extrudate. For example, the moving surface 50 might have porous walls and may be filled with or consists of a chamber 57 that is filled with a medium containing the additives or functional elements. Alternatively the additives or functional elements 65 could be “sprayed” or otherwise added from the outside onto the extrudate.

Particularly suitable additives will be those organic or inorganic substances able to facilitate the conversion of the feedstock 25 in its substantially initial fluid form to a substantially solid form for forming the fiber or film forming material. This may specifically involve also the addition of other natural or recombinant protein-based or peptide-based or non-biological liquid crystalline materials as additives.

For practicing the invention with, for example, silk protein feedstocks, the additives may include copper, known to enhance the formation of β-sheets (see, for example, Zhou et al “Effect of metallic ions on silk formation in the Mulberry silkworm, Bombyx mori, J. Phys. Come B Condens Matter Surf Interfaces Biophys, 8 Spe 2005; 109 (35) pp 16937-45, and Zhou et al “Copper in the silk formation process of Bombyx mori silkworm”, FEBS Lett., 20 Nov. 2003, 554 (3), pp 337-41).

The selection of additives that can be added is extensive and only limited by the intended use of the product. As examples, the following additives can be envisaged:
Inorganic or organic liquid crystals
Agents facilitating the conversion from liquid to solid crystal phase
Organic additives:
   Small molecular entities
   Peptides
   Proteins
   Carbohydrates
   Lipids
   Nucleic acids such as DNA, RNA, PNAs and other nucleic acid analogues with more than 100 bases length as well as fragments thereof with less than 100 bases length such as for example siRNAs
Inorganic additives:
   Additives or precursors that improve or render mechanical, optical, electrical or catalytic properties
   Minerals such as phosphates, carbonates, sulphates, fluorides, silicates etc. and mineraloids such as clays, talc, and silicas,
   Salts of alkali and alkaline earth metals, transition metals, post transition metals and alloys thereof,
   Metal complexes such as metal ions coordinated with EDTA or other chelating agents,
   Insulators such as metal oxides like Fe₂O₃, Al₂O₃, TiO₂,
   Any III-V or II-VI semiconductor and conductors, such as metals and alloys thereof,
   Carbon-based additives, such as fullerenes, carbon nanotubes, fibers or rods, graphite
Hydrophobic, hydrophilic or amphiphilic additives to adjust the physical properties of precursor biomaterials during the wetting, stretching and drying process
Nanoparticles
Physiologically active compounds such as
   Antibodies and their analogous
   Antiseptics, antiviral agents and antibiotics
   Anti-coagulants and anti-thrombotics
   Vasodilatory agents
   Chemotherapeutic agents
   Anti-proliferative agents
   Anti-rejection or immunosuppressive agents
   Agents acting on the central and peripheral nervous system
   Analgesics
   Anti-inflammatory agents
   Hormones such as steroids
   Mineralisation agents for tooth regeneration such as fluorapatite for tooth regeneration
   Mineralisation agents for bone regeneration such as hydroxylapatite, tricalcium phosphate, marine animal derived particles such as corals and chitosans and the like
   Growth factors such as
      bone morphogenic proteins BMPs
      bone morphogenic-like proteins GFDs
      epidermal growth factors EGFs
      fibroblast growth factors FGFs
      transforming growth factors TGFs
      vascular endothelial growth factors VEGFs
      insulin-like growth factors IGFs
      nerve repair and regeneration factors NGFs
      platelet-derived growth factors PDGFs
   Proteins functioning as cell or protein binding agents such as collagen IV, polylysine, fibronectin, cadherins, ICAM, V-CAM, N-CAM, selecting, neurofascin, oxonin, neuroglinin, fascilin
   Cell-binding motives such as for example the RGD or RADAR recognition sites for cell adhesion molecules
   Wound healing agents
   Agents for preventing scar-formation such as for example Cordaneurin or BMP-1
   Other naturally derived or genetically engineered therapeutically active proteins, polysaccharides, glycoproteins or lipoproteins
   Therapeutically active cells such as for example stem cells or autologous cells derived from a site of the patient
Agents for detecting changes of pH such as neutral red
Agents promoting β-sheet formation of precursor biomaterials
Agents such as biodegradable polymers which degrade at controllable rates thereby enabling controlled biodegradability
Agents such as protease inhibitors which inhibit protease activity for example in the site of implantation in the patient thereby enabling controlled biodegradability
Aprotic solvents improving hydrogen bond formation in peptides and proteins such as ether, ester, acid anhydride, ketones (e.g. acetone), tertiary amines, dimethylformamide, pyridine, furane, thiophen, trichlorethane, chloroform and other halogenated hydrocarbons, dimethylsulphoxide, dimethylsulphate, dimethylcarbonate, imsol, anisol, nitromethane.
Agents enhancing release of physiologically active compounds
Naturally derived or chemically synthesised dyes
Naturally derived or genetically engineered colouring agents such as green fluorescent protein
Naturally derived or genetically engineered structural load bearing proteins such as actin, silk, collagen, fibronectin and analogous or derivates thereof
Organic and inorganic electrically conducting and semi-conducting materials
Polyelectrolytes with bound positive or negative charges
Ionic liquids
Materials conferring transient or permanent magnetism
Water soluble polymers such as polylactic acid or polycaprolactone
Glass fibers

It should be understood that the list of additives is not intended to be limiting of the invention but is exemplary of the additives that can be added to the feedstock and precursor biomaterial.

Finally, the finished product 90 is taken-up by a material storage device 100 which is rotating.

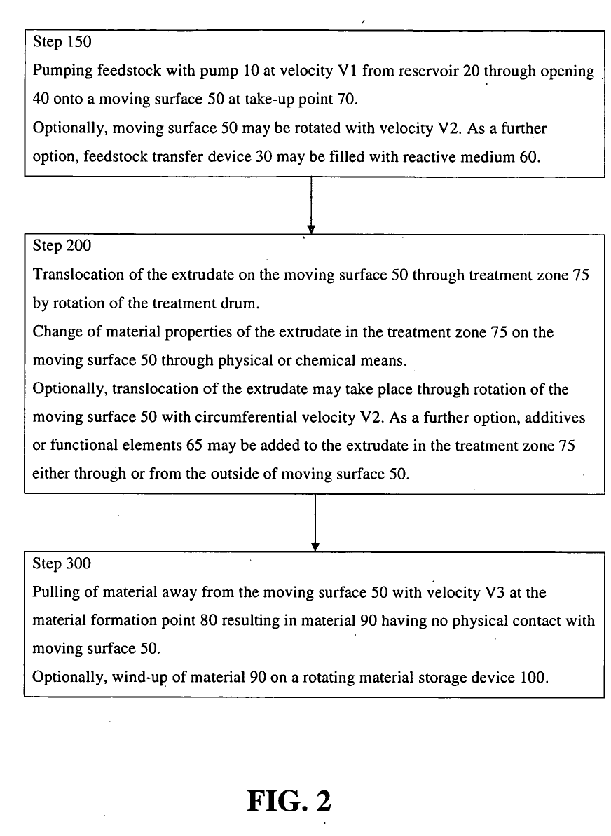

FIG. 2 shows an overview of the method of the invention.

In a first step 150, the feedstock 25 is pumped from the feedstock reservoir 20 through the channel 35 to the opening 40 onto the moving surface 50 at the take-up point 70. The moving surface 50 is rotating and imparts to the extrudate at the take-up point 70 a velocity V2 which may be similar or different to the velocity V1 of the feedstock 25 exiting the opening 40. Should the velocities V1 and V2 be different, the resulting speed differential will cause a physical shearing of the extruded material after exiting the opening 40.

In the next step 200, the treatment zone 75, which begins at the take-up point 70 and ends at the material formation point 80, may be used to change the physical and chemical properties of the extrudate and thereby enabling control of the formation of the material 90 and the crystallization process taking place on the moving surface 50. The control of the properties of the finished product 90 on the moving surface 50 may include sensing and/or actively changing physical and/or chemical parameters of the extrudate. Non-limiting examples include changing the magnetism, electrical conductivity, temperature, pH, ion or solvent concentration of the extrudate and thereby influencing the crystallization of the extrudate and material manufacturing process in a controlled fashion. The movement of the extruded material through the treatment zone 75 may take place by rotation of the treatment device 50.

The treatment zone 75 may also be used to change properties of the extrudate by transferring additives or functional elements 65 either through or from the outside of the moving surface 50 into the extrudate.

In the final step 300, at the material formation point 80, the extruded material 90 (which is a fiber or film forming material) is pulled away with a velocity V3 from the moving surface 50 such that the extruded material 90 no longer has any physical contact with the surface of the moving surface 50. The velocity V3 may be similar or substantially different to the velocity V2. Should the velocities V2 and V3 be different, the resulting speed differential will cause a physical shearing of the extruded material 90 at the material formation point 80. Optionally, the extruded material 90 may be wound up on the material storage device 100.

Subsequent to the leaving of the extruded material 90 from the moving surface 50, the extruded material 90 can be treated in, for example, a treatment bath as is known in the prior art. An example of a treatment bath is shown in U.S. Pat. No. 4,344,908.

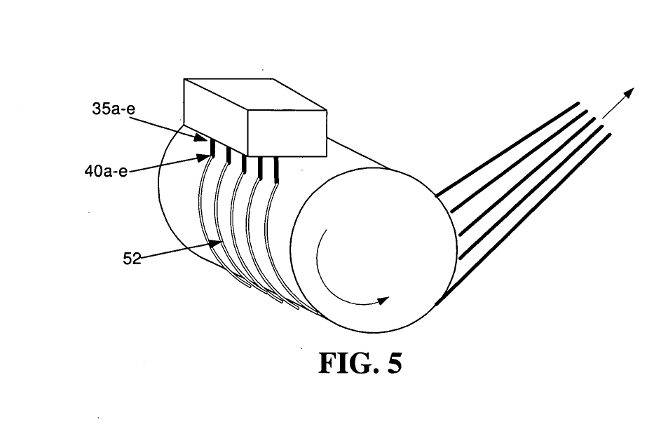

FIG. 5 shows an extrusion apparatus according to another aspect of the invention. FIG. 5 shows the moving surface 50 on which five tracks 52 of the extruded material are aligned in a parallel fashion. The extrusion apparatus has five channels 35a-e each of which has an opening 40a-e through which the feedstock 25 is passed onto the moving surface 50.

In an aspect of the present invention the end of the channel 35 has a flexible tip 42 at the opening 40. The flexible tip 42 is made from a flexible material such as a flexible plastic or a flexible rubber. The flexible plastic can be, but is not limited to a polyolefin, such as polypropylene or polyethylene. The flexible tip 42 at the end of the channel 35 means that the end of the channel 35 is not rigid in relation to the moving surface 50. As the moving surface 50 moves, the flexible tip 42, which may be in contact with the moving surface 50 does not impede a movement of the moving surface 50.

The invention will now be illustrated with reference to several examples. However, it will be appreciated that the invention is not limited to these examples and the skilled person will be able to apply the teachings more generally.

### Example 1

The extrusion process of the invention was started by pumping an aqueous feedstock comprising a fibroin solution of about 20% wt/v fibroin concentration with a velocity V1 of about 0.3 mm/s through a channel with inner diameter of 0.7 mm onto a drum which rotates with a circumferential velocity V2 of about 1.5 mm/s and has a diameter of about 50 mm. The distance between the opening of the channel and the surface of the drum in this instance is less than 1 mm. The drum forms the moving surface.

The aqueous feedstock was prepared according the method described in UK Patent Application No. 0604089.3 “Method and Apparatus for Extraction of Arthropod Gland” filed by the Applicants, the disclosure of which is incorporated herein by reference. The drum was heated to a temperature of between 40 and 50° C. thereby enabling control of fiber formation on the surface of the drum through evaporation of the solvent from the extrudate. As soon as the extrudate was dry enough for pick-up with a pair of forceps, the fiber was drawn from the drum and stretched through transfer to a take-up roller with velocity V3 of about 6 mm/s. The fiber was collected on a take-up wheel.

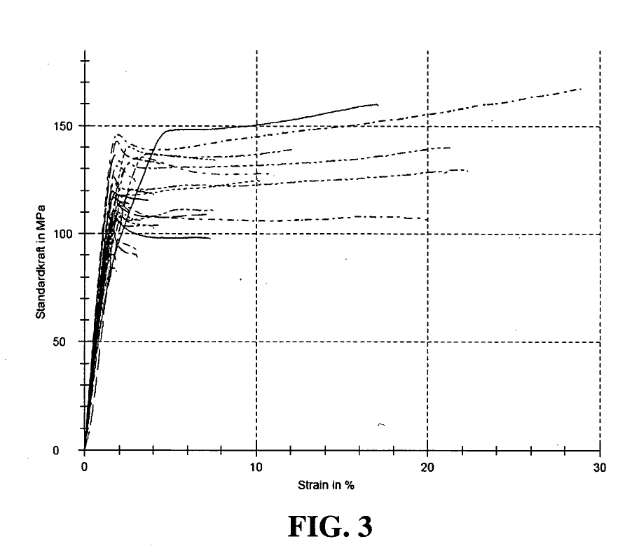

For tensile testing, three spun fibers (of length 0.6, 0.9, 1.8 m) were divided into 47 samples having a sample length of about 50-150 mm. The stress-strain curves are plotted in FIG. 3. The fibers had a tensile strength of 115 MPa and a tensile Modulus of 8.2 GPa with about 5-6% strain. The tensile testing values are listed in Table 1. The tensile testing was performed with a Zwick/Roell Z2.5 tensile tester at a crosshead speed of 10 mm/min. The fibers were water insoluble and had silk-like optical and haptical properties.

TABLE 1

| Series | Rm | EMod | AB |
|---|---|---|---|
| n = 47 | MPa | MPa | % |
| x | 114.86 | 8231.22 | 5.48 |
| s | 20.17 | 844.71 | 6.60 |
| min | 60.84 | 6601.90 | 0.88 |
| max | 167.29 | 10197.94 | 28.91 |

### Example 2

A fibroin feedstock solution of about 7% wt/v fibroin concentration was extruded with a velocity V1 of 0.27 mm/s through a 0.8 mm channel onto a drum which rotates with a circumferential velocity of 1.5 mm/s and has a diameter of about 50 mm. The extruded material was then transported by the drum into a biological buffer bath containing 3 mM Copper. Following gelation of the extruded material on the drum after contact with the buffer bath, the extruded material was then picked up with a pair of forceps and collected on a take-up wheel as described in Example 1.

Tensile testing was performed of the finished product (at 10 mm crosshead speed) and shows that the “wet-spun” monofilaments (2.45 tex) had a tensile strength of 185.1 MPa and a tensile modulus of 5.9 GPa at a breaking elongation of 23.4%. The fibers were water insoluble and had silk-like optical and haptical properties.

### Example 3

A fibroin feedstock solution of about 10% wt/v fibroin concentration was extruded with a velocity V1 of 0.27 mm/s through five 0.8 mm channels aligned in a parallel fashion as demonstrated in FIG. 5 onto a drum. The extruded material was then treated as described in Example 2. The extruded fibers were water insoluble and had silk-like optical and haptical properties.

Having thus described the present invention in detail, it is to be understood that the foregoing detailed description of the invention is not intended to limit the scope of the invention. One of ordinary skill in the art would recognise other variants, modifications and alternatives in light of the foregoing discussion.

What is desired to be protected by Letters Patent is set forth in the following claims.

What is claimed is:

1. An apparatus for the extrusion of a silk fiber from a water-soluble material comprising:
a material supplier supplying the water-soluble material and having at least one opening, the water-soluble material being extruded through the at least one opening to form the silk fiber; and
a moving surface adjacent to the at least one opening and receiving the silk fiber from the at least one opening.

2. The apparatus according to claim 1, wherein the material supplier comprises a material reservoir and a feedstock loading device.

3. The apparatus according to claim 1, wherein the moving surface is heatable.

4. The apparatus according to claim 1, wherein a rate of movement of the moving surface determines the rate of extrusion of the silk fiber.

5. The apparatus according to claim 1, wherein a distance of between 0 to 50 mm separates the moving surface from the at least one opening.

6. The apparatus according to claim 1, wherein the water-soluble material comprises fibroin.

7. The apparatus according to claim 1, wherein the water-soluble material comprises a silkworm-derived material.

8. The apparatus according to claim 1, wherein the moving surface comprises of a permeable surface.

9. The apparatus according to claim 1, wherein the water-soluble material is self-assembling.

10. The apparatus according to claim 1, wherein the moving surface is substantially cylindrical.

11. The apparatus according to claim 1, further comprising a storage device for storage of the extruded silk fiber.

12. The apparatus according to claim 1, further comprising a treatment zone in which the extruded silk fiber is released from the moving surface.

13. The apparatus according to claim 1, wherein the moving surface comprises a permeable surface through which additives are passable.

14. The apparatus according to claim 1, further comprising a treatment bath through which the extruded silk fiber is passed.

15. The apparatus according to claim 1, wherein the opening is in the form of a flexible tip.

16. The apparatus according to claim 15, wherein the flexible tip is made from a flexible plastic or a flexible rubber.

17. The apparatus according to claim 16, wherein the flexible plastic is selected from the group consisting of a polypropylene or a polyethylene.

18. A method for the extrusion of a silk fiber from a water-soluble material comprising:
providing the water-soluble material in aqueous form;
extruding the water-soluble material through at least one opening to form the extruded silk fiber; and
receiving the extruded silk fiber on a moving surface situated adjacent to the at least one opening.

19. The method of claim 18, further comprising treating the extruded silk fiber on the moving surface.

20. The method according to claim 18, wherein the moving surface is heated.

21. The method according to claim 18, wherein a rate of movement of the moving surface determines the rate of extrusion of the silk fiber.

22. The method according to claim 19, wherein the treating of the extruded silk fiber comprises changing the physical state of the extruded material.

23. The method according to claim 18, wherein the water-soluble material is self-assembling.

24. The method according to claim 18, wherein the water-soluble material comprises fibroin.

25. The method according to claim 18, wherein the water-soluble material comprises a silkworm-derived material.
